(19) United States
(12) Patent Application Publication
(10) Pub. No.: US 2005/0038698 A1
(43) Pub. Date: Feb. 17, 2005

(54) Targeted advertisement with local consumer profile

(76) Inventors: Rajan M. Lukose, Palo Alto, CA (US); Joshua R. Tyler, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/639,140

(22) Filed: Aug. 12, 2003

(51) Int. Cl. G06F 17/60

(52) U.S. Cl. 705/14

(57) ABSTRACT

A computer that comprises a monitor, a CPU, memory coupled to the CPU, and an instruction storage medium coupled to the CPU. The instruction storage medium provides instructions executable by the CPU, whereby the computer logs consumer activities, creates a local consumer profile based on said consumer activities, and displays an advertisement on the monitor if a target profile of said targeted ad matches the local consumer profile.

### BACKGROUND

The Internet couples millions of computers together and provides computer users with a variety of capabilities. For example, using the Internet, computer users may view text and graphics, make purchases, send and receive electronic mail, and search for information. As a result, the Internet has become a valuable tool.

Due to the number of computer users that access the Internet, advertising on the Internet has developed into a significant market. Common types of Internet advertisement services include “spam” email (unsolicited commercial email), pop-up advertisement banners, and consumer profiling (i.e., tracking and selling consumer information including Internet activities).

Unfortunately, there are many shortcomings in these Internet advertisement services. For example, spam email and advertisement banners may not effectively target consumers and can be highly inefficient. Further, consumer profiling may encroach on consumer privacy.

### BRIEF SUMMARY

In accordance with some embodiments of the invention, a computer comprises a monitor, a CPU, memory coupled to the CPU, and an instruction storage medium coupled to the CPU. The instruction storage medium provides instructions executable by the CPU, whereby the computer logs consumer activities, creates a local consumer profile based on said consumer activities, and displays an advertisement on the monitor if a target profile of said targeted ad matches the local consumer profile.

### BRIEF DESCRIPTION OF THE DRAWINGS

For a detailed description of the embodiments of the invention, reference will now be made to the accompanying drawings in which:

FIG. 1 shows a block diagram illustrating a system according to an embodiment of the present invention;

FIG. 2 shows a block diagram illustrating a system according to another embodiment of the present invention;

FIG. 3 shows a flowchart illustrating a method for advertising according to an embodiment of the invention; and

FIG. 4 shows a flowchart illustrating a method for advertising according to another embodiment of the invention.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to.” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

There is presented herein various embodiments of an advertising technique that may be beneficial to, among other entities, advertisers and consumers. More specifically, the embodiments of the present invention permit advertisers to find consumers that match a desired consumer profile, while permitting consumers to control their own personal information. The following describes the embodiments of the invention in terms of consumers and advertisers merely by way of example, and is not limited to that context.

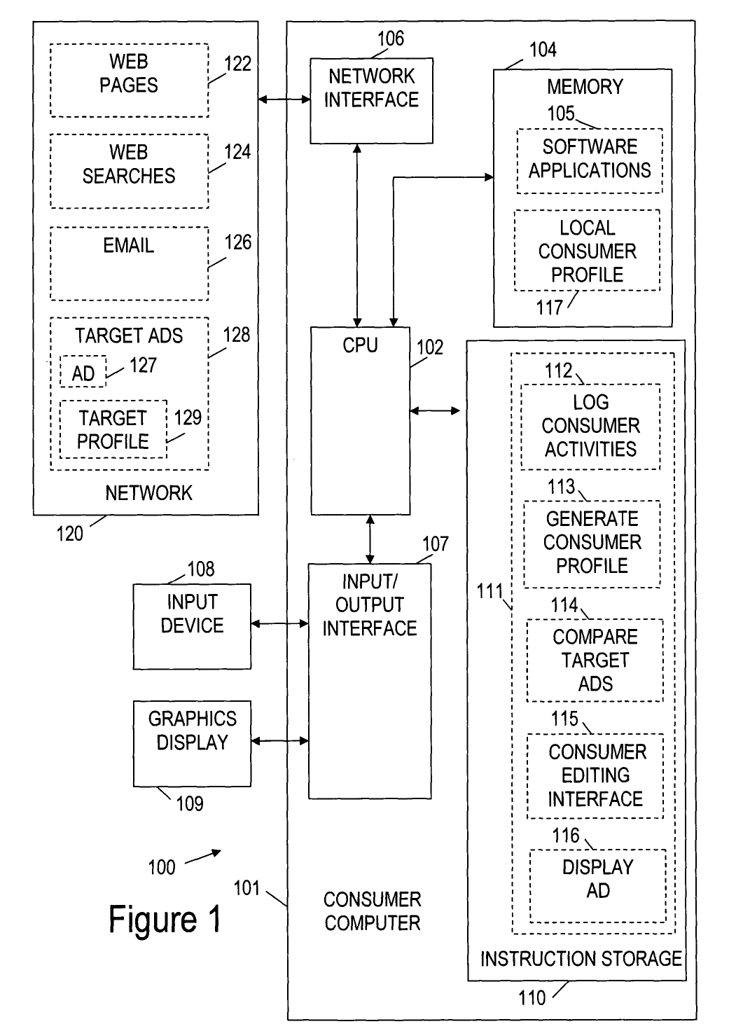

FIG. 1 shows a block diagram of a system 100 according to an embodiment of the present invention. As shown in FIG. 1, the system 100 may comprise a consumer computer 101 coupled to a network 120, an input device 108, and a graphics display 109. The consumer computer 101 may comprise a CPU (central processing unit) 102 coupled to a memory 104, a network interface 106, an input/output interface 107, and an instruction storage medium 110. The instruction storage medium 110 may comprise any of a variety of media for storing computer-readable instructions. Examples of a suitable instruction storage medium 110 include, a floppy disk, a compact disk, a volatile memory, a non-volatile memory, a hard drive, or a combination thereof. In at least some embodiments, the memory 104 and the instruction storage medium 110 may be the same. The memory 104 may comprise software applications 105 and a local consumer profile 117.

As shown in FIG. 1, the network 120 couples to the consumer computer 101 through a network interface 106. The consumer computer 101 may receive electronic content such as web pages 122, search engine results 124, email 126, and targeted advertisements (“ads”) 128 from the network 120. In at least some embodiments, a user of the consumer computer 101 may specify, through the network interface 106, the content that the consumer computer 101 receives from the network 120 by inputting information (e.g., Internet domain names) using an input device 108, which may comprise a keyboard and/or a mouse.

The instruction storage medium 110 provides computer-readable instructions 111 for execution by the CPU 102 to enable the consumer computer 101 to perform various functions. As shown, the computer-readable instructions may comprise log consumer activities instructions 112, generate consumer profile instructions 113, compare target ads to consumer profile instructions 114, consumer profile edit instructions 115, and display advertisement instructions 116.

More specifically, the log consumer profile instructions 112 may comprise code that targets and recognizes when certain computer activities occur. For example, the instructions 112 may systematically sample the operation of CPU 102 and/or network interface 106 to recognize the software applications 105 that are used, web pages 122 that are accessed, time spent browsing those web pages 122, web searches 124 that are performed, and email 126 usage. Additionally, the instructions 112 may function with the CPU 102 and the memory 104 to store information regarding the software applications 105 that are used, web pages 122 that are accessed, time spent browsing those web pages 122, the web searches 124 performed, and email 126 usage.

The generate consumer profile instructions 113 may work with the logging instructions 112 to enable the consumer computer 101 to organize the consumer activities information acquired as described above. For example, the instructions 113 may generate a database (data structure) from the stored consumer activities information so that an inquiry regarding specific consumer activities may be made by accessing and searching the database. As shown in FIG. 1, a local consumer profile 117 may be generated by the instructions 113.

The compare target ads instructions 114 preferably provides a local, secure interface so that target profiles 129 embedded in a target ad 128 and received by the consumer computer 101 may be compared to the local consumer profile 117 stored in the memory 104 without compromising consumer privacy. The consumer editing interface instructions 115 enables an operator of the computer 101 to make changes to the local consumer profile 117. For example, it may be desirable that an operator of the computer 101 delete and/or add information to the local consumer profile 117. Therefore, the instructions 115 may open a window that permits the operator to view information in the profile 117 and make changes to that profile 117.

The display ad instructions 116 may work with the compare target ads instructions 114 to present an advertisement 127 to an operator of the computer 101 when a predetermined amount of target consumer activities of the target profile 129 are contained in the local consumer profile 117. For example, the instructions 116 may enable a popup advertisement or another advertisement to be displayed on the graphics display 109.

In general, the instruction storage medium 100 causes the computer 101 to log computer activities, create a local consumer profile that comprises a first set of information, receive a targeted advertisement containing a second set of information, compare the first set of information to the second set of information, and present the targeted advertisement on the computer 101 if a required amount of the second set of information matches with the first set of information.

The local consumer profile 117 may comprise user-specified criteria pertaining to which advertisements the user of a computer wishes to be shown on the computer 101. If the targeted ad 128 does not contain information that falls within the user specified criteria, that targeted ad is precluded from being displayed to the user. As previously explained, the user specified criteria may be stored in the local consumer profile 117 and may comprise an inventory of logged user activities. Additionally, or alternatively, user specified criteria may comprise a consumer ask price. The consumer ask price preferably is adjustable and may be set by the consumer as a minimum price that advertisers pay to the consumer for his/her attention to an advertisement. The consumer ask price may be an amount of money, or some other reward such as coupons, points that may be used to make purchases, airline miles, or free gifts. The consumer ask price allows the consumer to control the value of his/her attention to an advertisement and discourages advertisers from sending unsolicited advertisements by requiring the advertiser to pay each consumer for his/her attention to an advertisement at a price controllable by the consumer.

In embodiments that use both consumer activities and a consumer ask price for the local consumer profile 117, the target profile 129 may comprise a set of target consumer activities and a bid price. If the set of target consumer activities (2^{nd} set of information) matches a minimum amount of consumer activities (1^{st} set of information) stored in the local consumer profile 117 and the bid price is greater than or equal to the consumer ask price, then the ad 127 may be presented to the operator of the consumer computer 101 through the graphics display 109.

In at least some embodiments, the computer-readable instructions 111 may execute on the CPU 102 in the background of the consumer computer 101. For example, the log consumer activities instructions 112 may enable the consumer computer 101 to track transparently a wide variety of consumer activities such as usage of the software applications 105, web pages 122 visited, time spent on those web pages, web searches 124 performed, and email 126 usage. As previously explained, some or all of the logged information may be included in the local consumer profile 117.

The input device 108, the graphics display 109, and the consumer editing interface 115 allow the operator of the consumer computer 101 to control the information stored in the local consumer profile 117. For example, a particular consumer may view his/her local consumer profile 117, and modify the profile by deleting information in the profile 117 and/or adding information to the profile 117. Accordingly, the local consumer profile 117 may contain only those elements that the consumer wants to make available for comparison with the targeted ads 128. In some embodiments, a consumer may not add information to his/her profile 117, as it may be desirable to protect the validity of consumer activities stored in the profile 117. Furthermore, in some embodiments, a consumer may not edit the profile 117, but may still choose to enable or disable the function of the instructions 111 as described above. For example, the instructions 111 may not provide a user interface whereby the profile 117 is editable. In embodiments where the profile 117 is preferably not editable, code obfuscation (i.e., intentionally making the source code hard to understand) may be used to prevent software hackers from accessing and/or editing the profile 117. Additionally, some computers 101 may use special hardware that would prevent the profile 117 from being manipulated. This technology is referred to as the Trusted Computing Platform (“TCP”).

By keeping the local consumer profile 117 on the consumer computer 101 (e.g., in the memory 104), consumer privacy is maintained while allowing the consumer to receive advertisements for products and services that may be of interest to the consumer based on information in the local consumer profile 117. In at least some embodiments, advertisers do not know when the targeted ads 128 match the consumer profile 117. Preferably, only when consumers choose to view an ad 127 is it possible for information about the profile 117 to be released to an advertiser.

The release of personal information may be controlled in several ways, including, but not limited to, sending an ad 127 that is viewable by the consumer without accessing an outside server. If the ad 127 is viewed by accessing an outside server, e.g., accessing a universal resource locator (“URL”), the owner of the outside server would be entrusted not to reveal information about accesses to advertisers. Other, more sophisticated, techniques are also possible, for example, data encryption protocols or cyptographic protocols, that have been, or may be, developed.

An advertiser may choose the content of a targeted ad 128. Specifically, an advertiser may select, or otherwise generate, the ad 127 and the target profile 129 to suit the needs of the particular advertiser. As previously explained, the target profile 129 may comprise a set (criteria) of consumer activities and a bid price. If a local consumer profile 117 matches the target profile 129 as previously explained, an advertisement is displayed on the graphics display 109. The advertisement may be presented in variety of ways including, but not limited to, a popup ad, or a less invasive flashing icon appearing on the graphics display 109.

For example, the display ad instructions 116 may enable the computer 101 to provide an icon on the graphics monitor 109 that shows a value meter of incentives that are waiting to claimed by viewing advertisements 127. By double-clicking on the icon, the instructions 111 may cause an application with a viewable window to appear wherein the consumer may view details of a targeted ad 128, such as sponsor, available reward, advertisement type (e.g., video, web page, text), an advertisement link, an expiration date of the offer, and target profile information. By clicking on the advertisement link, the consumer is shown the advertisement 127. After viewing the advertisement 127, the application window may display a summary of earned incentives. The application window may also provide the consumer with a method of inputting the consumer ask price, and a method for collecting the incentive (e.g., direct deposit to a bank account, links to websites where coupons are redeemed or where purchase points and/or airline miles are stored).

As previously mentioned, the system 100 permits advertisers to target consumers with a targeted ad 128. In at least some embodiments, the targeted ads 128 preferably are viewable only by a computer 101 with the instructions 111 installed. In such embodiments, a public/private key pair that encrypts the targeted ads 128 may be used to ensure that only the computers 101 with the instructions 111 are able to view the targeted ads 128. Therefore, consumers may be enticed to purchase an instruction storage medium 110, or a computer 101, with the instructions 111 so that they can use the system 100 to receive incentives from advertisers as previously explained.

As an example, suppose an advertiser is in search of a consumer who has at least twice (e.g., separated in time by at least 5 hours) spent time on three web sites (X, Y, Z) related to automobiles, and has viewed web pages describing SUVs made by automobile companies A and B. The advertiser may further require that the consumer has done an Internet search during the last three weeks containing the terms “SUV” and “safety”, but who has never visited the website of automobile company C, who also makes SUVs. The advertiser (e.g., automobile company C) may be willing to pay, for example, $3 to a consumer for his/her attention, if the above criteria are met. Therefore, the advertiser would generate a target ad 128 in which the target profile 129 contains the website visits, the web searches, and time requirements specified above. The target profile 129 may also include a bid price of $3. At the consumer computer 101, the target ad 128 is received, and the target profile 129 is compared to the local consumer profile 117 using the compare target ads instructions 114. If the above criteria of target profile 129 is found within the local consumer profile 117, the ad 127 would be displayed on the graphics display 109 using the display ad instructions 116. As previously explained, the target profile 129 may include a bid price and the local consumer profile 117 may include a consumer ask price. In the above example, the consumer ask price would need to be $3 dollars or less for the ad to be displayed (assuming the advertiser submitted a bid price of $3).

The advertisement 127 of a targeted ad 128 may also be customized to the consumer. As an example, an advertisement 127 based on the criteria given above may include the statement, “Reasons why SUV of automobile company C is superior to the SUVs of automobile companies A and B”. Given the consumer's recent behavior and the cash incentive, the consumer may be willing to spend time to view the advertisement. The consumer also may be a discriminating consumer who dislikes unsolicited advertisements, and may accordingly set his/her consumer ask price at, for example, $2. Therefore, only the targeted ads 128 that include a bid price incentive of at least $2 will be displayed to the consumer, even if the target consumer activities included in the target profile 129 are found in the local consumer profile 117.

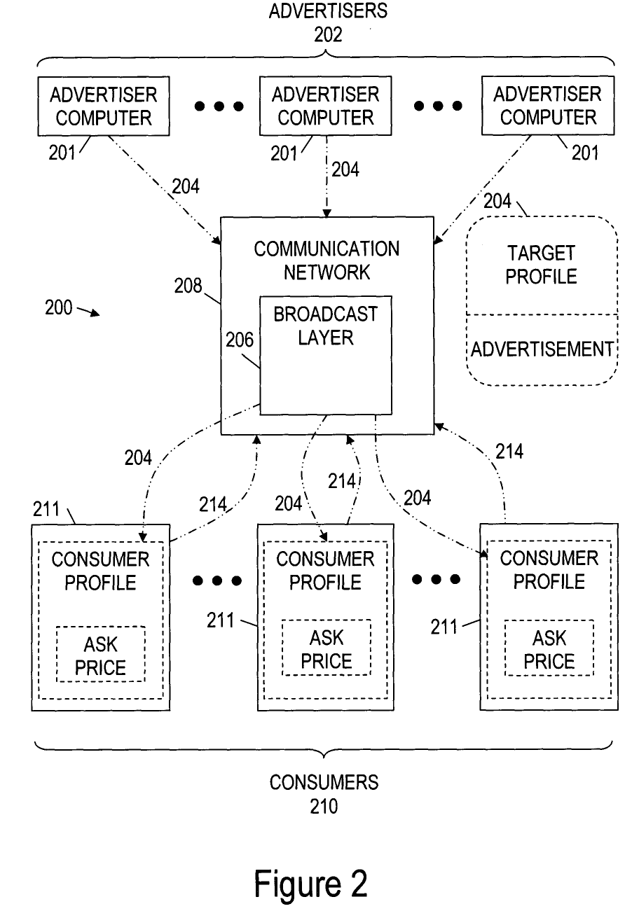

FIG. 2 shows a block diagram illustrating a system 200 according to another embodiment of the invention. As shown in FIG. 2, the system 200 may comprise a plurality of advertiser computers 201 and consumer computers 211 coupled to each other through a communication network 208 having a broadcast layer 206. The advertisers 202 may use the computers 201 to send advertisement messages 204 to the communication network 208. Each advertisement message 204 may comprise a target profile and an advertisement. As previously explained, the target profile may comprise a set of target consumer activities and a bid price. In at least some embodiments, the communication network 208 may be a server that broadcasts targeted ads 204 to the consumer computers 211. As shown in FIG. 2, each consumer computer 211 may contain a consumer profile and an ask price. In at least some embodiments, the network 200 may be combined with existing spam blocking tools, whereby unknown advertisers would pay the consumers 210 for their attention to advertisements.

The broadcast layer 206 may be one of, or a combination of several possibilities that include, but are not limited to, a direct server to PC (personal computer) connection over the Internet, an indirect connection through a peer-to-peer scheme (i.e., each party may control initiation of a communication session), or a datacasting method (i.e., satellite communications) that broadcasts a digitized advertisement message 204 over a television infrastructure. The communication network 208 may send the advertisement messages 204 to all or some of the consumer computers 211 using the broadcast layer 206.

As previously explained, the consumers 210 may control participation in the network 200. For example, a consumer may disable the consumer profile on his/her computer 211. In contrast, the consumer profile may be configurable, whereby an operator of a computer 211 may change his/her consumer profile, including an ask price. An operator also has the option of simply not responding to advertisements that match the consumer profile. If a required portion of the target profile an advertisement message 204 matches a consumer profile as previously described, a consumer 210 may choose to view or not to view the advertisement attached, or otherwise included, with advertisement message 204.

As previously described, the target profile may comprise a set of targeted consumer activities. For example, consumer activities may be associated with transactions an operator performs over a network such as web browsing, web searches, and email usage. Alternatively, or additionally, the consumer activities may be associated with software applications that an operator uses on the consumer computer 211. The target profile also may comprise a bid price. As previously explained, a bid price may comprise cash, coupons, airline miles, points used for purchasing, and/or free gifts. In at least some embodiments, the advertisement of an advertisement message 204 may comprise an Internet hyperlink that permits the user to view the advertisement on the Internet by sending a response 214 to the communications network 208.

There are at least two ways to control the amount of incentives that a consumer receives for viewing an advertisement. In general, a function V(A, B) that describes the relationship between consumer ask price (“A”) and bid price (“B”) may be included in the advertisement message 204 or the instructions 111 (FIG. 1). For example, if A=$3 and B=$5, V(A, B) determines whether the consumer receives $3 or $5 or something in between. If V(A, B)=A, then a consumer only receives the consumer ask price A for viewing an advertisement, even if B is more valuable than A. However, if V(A, B)=B, the consumer receives the bid price B for viewing an advertisement. Using a V(A, B)=A relationship may encourage a consumer to set his/her ask price A high enough to make viewing advertisements worthwhile. For example, a consumer who sets the consumer ask price A at $0, will not receive any incentive for viewing ads attached to an advertisement message 204 if the V(A, B)=A relationship is used.

Alternatively, a function T(V(A, B)) may programmed into the advertisement messages 204 or the instructions 111 (FIG. 1). The function T(V(A, B)) may be the same as V(A, B) explained above except that a portion of any incentive offered by an advertiser to a consumer is given to the owner of network 208. For example, the network owner may receive 25% of the incentive given to the consumer.

In is noted that minimizing and mitigating threats to the integrity of the advertising network 200 may be considered. For example, a consumer 210 may be tempted to scam the network 200 in order to receive as many advertiser 202 incentives as possible. Accordingly, the network 200 may implement a variety of defenses to prevent or minimize the occurrence of scams. For example, the network 200 may cap the amount of incentives that a consumer is able to receive per time period (e.g., hour, day, week, or month). In some embodiments, the target profile of advertisement message 204 may require that consumers 210 actually have made purchases of a product and/or require a highly specific set of target consumer activities. Furthermore, consumers 210 may be required to view the advertisement and input certain information before they can receive the incentive offered. Further still, methods of accessing advertisements that prevent computer automated accesses may be implemented (e.g., Turing tests).

Another solution may involve each consumer computer 211 having two versions of the consumer profile. For example, one version may be plaintext, and the other may be a hashed (i.e., encrypted) version of the profile. In this embodiment, the hashed version may be a one-way global function accessible by network 208. The target profiles could be sent in hashed form also, and compared against the hashed version of a consumer profile. Only if a match occurs can the plaintext of the target profile be determined (e.g., a hashed value in a location of hashed profile may correspond to a plaintext value in the plaintext version at the same relative location). If no match of hashed values occurs, then the plaintext value cannot be determined (because there is no matching entry in the hashed profile database). This solution would inhibit hackers and malicious users, by requiring they actually perform the activities required by a target profile before viewing an advertisement and receiving any incentive.

Advertisers 202 also may threaten the integrity of the network 200. For example, an advertiser 202 may try to discover information and identities about the consumers 210. Accordingly, the communications network 208 should ensure that the advertisement messages 204 contain no web bugs that comprise, for example, programs written to allow an advertiser 202 to match an Internet Protocol (IP) address with the fact that a target profile matched a consumer profile associated with that address. Preventing web bugs as described above may be accomplished by examining the advertisement messages 204 before they are broadcast and destroying any advertisement messages 204 that include web bugs or other detrimental programs.

Other considerations relevant to the network 200 may include limiting the cost of advertising using the network 200. For example, some advertisers 202 may not want to pay an unknown quantity of incentives to consumers. Limiting advertiser expense may be accomplished by one or more methods including, but not limited to, capping the number of matching customers that will receive an incentive, sampling a small percentage of the overall population of an area and estimating the result of an advertisement from the sampling, using a peer-to-peer architecture to estimate the number of matching consumers, and implementing Internet voting protocols.

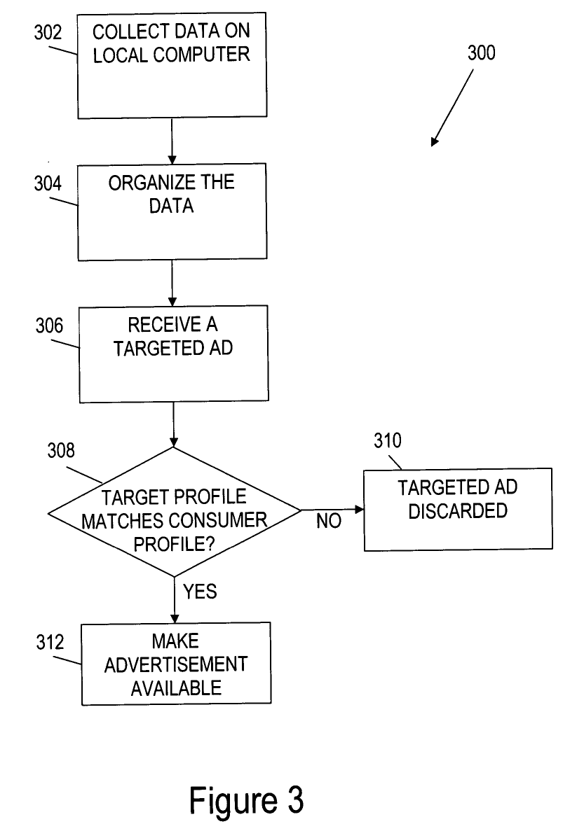

FIG. 3 shows a method 300 for advertising according to an embodiment of the invention. As shown in FIG. 3, the method comprises collecting consumer data on a local computer (block 302), and organizing the consumer data (block 304). As previously explained with regard to FIG. 1, a consumer profile may be generated and used to organize the consumer data. The method 300 further comprises receiving a targeted ad (block 306). As described in FIG. 2, a targeted ad (advertisement message) may comprise a target profile, and an advertisement. If the target profile matches a consumer profile as determined by block 308, an advertisement is made available (block 312) to consumer. For example, a popup ad or icon may appear immediately or at a later time. Otherwise, the targeted ad is discarded (block 310). As previously explained, a target profile may match a consumer profile when a set of target consumer activities included with the target profile are found in consumer profile. Additionally, or alternatively, a bid price that is greater than or equal to a consumer ask price may determine when a target profile matches a consumer profile.

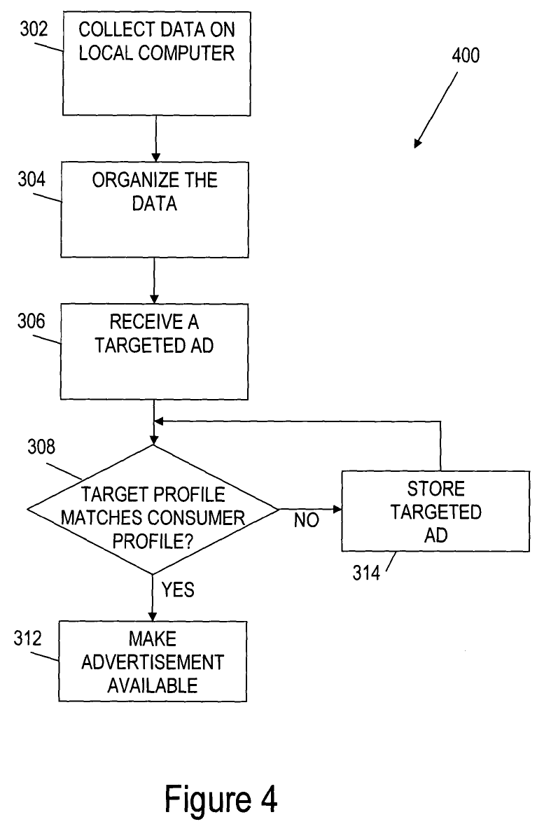

FIG. 4 shows a method 400 of advertising according to another embodiment of the invention. As shown, method 400 is generally identical to the method 300 described above. However, the method 400 does not discard targeted ads (block 310, FIG. 3) when they do not match the consumer profile (block 308, FIG. 4) as described for method 300. Instead, the targeted ads may be stored (block 314) and compared to the consumer profile at a later time. The method 400 permits several functions including, but not limited to, displaying targeted ads according to later consumer activities, e.g., web searches or web sites visited, without requiring multiple broadcasts of the targeted ad. Using this method 400, a targeted ad may be broadcast only once, but will effectively appear at a time when a consumer has met the target consumer criteria.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. A computer, comprising:
a monitor;
a CPU;
memory coupled to the CPU; and
an instruction storage medium coupled to the CPU, the instruction storage medium provides instructions executable by the CPU, whereby the computer logs consumer activities, creates a local consumer profile based on said consumer activities, and displays an advertisement on the monitor if a target profile of a targeted advertisement matches the local consumer profile.

2. The computer of claim 1, wherein the consumer activities comprise an activity selected from the group consisting of web sites visited, software applications used by the computer, web searches performed, and email usage.

3. The computer of claim 1, wherein the consumer profile further comprises a consumer ask price and the target profile further comprises a bid price.

4. The computer of claim 1, wherein the target profile comprises a set of target consumer activities selected from the group consisting of web sites visited, software applications used by the computer, web searches performed, and email usage.

5. The system of claim 1, wherein the target profile of said targeted ad matches the consumer profile if a set of target consumer activities of the targeted ad is found within the local consumer profile and a bid price is greater than or equal to a consumer ask price.

6. The system of claim 3, wherein the consumer is offered an incentive for viewing the advertisement.

7. The system of claim 6, wherein the incentive is equal to the consumer ask price.

8. The system of claim 6, wherein the incentive is equal to the bid price.

9. The system of claim 1, wherein an operator of the computer can edit the local consumer profile.

10. The system of claim 1, wherein an operator of the computer cannot edit the local consumer profile.

11. A system, comprising:
a first computer;
a communication network that receives a message, having a target profile and an advertisement, from the first computer and broadcasts the message; and
a second computer that receives the message from the communication network, compares the target profile of the message with a consumer profile, and displays the advertisement of the message if a required portion of the target profile matches the consumer profile.

12. The system of claim 11, wherein said consumer profile comprises a log of activities performed by the second computer and the target profile comprises a set of target consumer activities.

13. The system of claim 12, wherein said log of activities is associated with transactions an operator of the second computer performs over the communications network.

14. The system of claim 12, wherein said log of activities is associated with a software application used on the second computer.

15. The system of claim 11, wherein the consumer profile is configurable by an operator of the second computer.

16. The system of claim 11, wherein said consumer profile comprises a consumer ask price and said target profile comprises a bid price.

17. A method, comprising:
collecting data on a consumer computer;
receiving a targeted ad containing criteria and a bid price;
comparing said criteria with the data;
making an advertisement available on the computer if the criteria matches elements of the data and the bid price of the targeted ad is greater than or equal to a consumer ask price.

18. The method of claim 17, wherein said collecting, receiving, comparing, and displaying are performed locally on the consumer computer.

19. The method of claim 17, wherein said collected data comprises information that relates to consumer activities using a computer.

20. The method of claim 17 further comprising storing a targeted ad if the criteria does not match elements of the data or the bid price of the targeted ad is less than a consumer ask price.

21. A storage medium containing computer-readable instructions that are executable by a computer and cause the computer to:
log computer activities;
create a local consumer profile that comprises a first set of information;
receive a targeted advertisement containing a second set of information;
compare the first set of information to the second set of information; and
present the targeted advertisement on the computer if a required amount of the second set of information matches with the first set of information.

22. The storage medium of claim 21, wherein said local consumer profile further comprises a consumer ask price.

23. The storage medium of claim 21, wherein said first and second sets of information comprises computer activities related to consumers.

24. The storage medium of claim 21, wherein said computer-readable instructions further cause the computer to edit the local consumer profile according to input from an operator of the computer.

25. A system, comprising:
means for receiving a targeted ad;
means for comparing information embedded in the targeted ad with user controlled criteria pertaining to which ads are to be shown on the system;
showing the targeted ad if the targeted ad falls within the user specified criteria;

26. The system of claim 25 further comprising means for precluding the ad from being shown if the information does not fall within the user specified criteria.

27. The system of claim 25 wherein said user specified criteria comprises a price paid to a user of the system for viewing the targeted ad.
